(19) United States
(12) Patent Application Publication
(10) Pub. No.: US 2017/0141908 A1
(43) Pub. Date: May 18, 2017

(54) METHOD FOR ALLOWING USER EQUIPMENT (UE) TO PERFORM UE-FLEXIBLE TIME DIVISION DUPLEX (TDD) MODE COMMUNICATION IN NETWORK CONFIGURED TO SUPPORT UE-FLEXIBLE TDD MODE IN WHICH BASE STATION (BS) OPERATES IN FULL DUPLEX MODE AND UE OPERATES IN HALF DUPLEX MODE, AND THE USER EQUIPMENT (UE) FOR THE SAME

(71) Applicant: LG ELECTRONICS INC., Seoul (KR)

(72) Inventors: Jinmin KIM, Seoul (KR); Jaehoon CHUNG, Seoul (KR); Genebeck HAHN, Seoul (KR); Eunjong LEE, Seoul (KR); Kwangseok NOH, Seoul (KR)

(73) Assignee: LG ELECTRONICS INC., Seoul (KR)

(21) Appl. No.: 15/317,929

(22) PCT Filed: Dec. 24, 2014
(86) PCT No.: PCT/KR2014/012806

§ 371 Date: Dec. 9, 2016

Related U.S. Application Data
(60) Provisional application No. 62/011,054, filed on Jun. 12, 2014.

(51) Int. Cl. H04L 5/14; H04W 72/12; H04L 5/16; H04W 72/04

(52) U.S. Cl. CPC H04L 5/14; H04W 72/042; H04W 72/1268; H04L 5/16

(57) ABSTRACT

A method for performing communication by a user equipment (UE) in a UE-flexible Time Division Duplex (TDD) mode in a network configured to support the UE-flexible TDD mode in which a base station (BS) operates in a full duplex mode and a user equipment (UE) operates in a half duplex mode is disclosed. The method includes receiving information regarding UE-specific UL/DL (Uplink/Downlink) configuration configured in the UE from the base station (BS); if a ratio of a UL sub frame in the UE-specific UL/DL configuration is greater than ½, receiving a UL downlink control information (DCI) format including an uplink (UL) index value in a scheduled downlink sub frame from the base station (BS); and. recognizing a scheduled uplink (UL) sub frame based on the information regarding the UE-specific UL/DL configuration and the UL index value contained in the UL DCI format, and transmitting an uplink (UL) signal through the scheduled UL subframe.

### TECHNICAL FIELD

The present invention relates to wireless communication, and more particularly to a method for allowing a user equipment (UE) to perform UE-flexible TDD mode communication in a network configured to support the UE-flexible TDD mode in which a base station (BS) operates in a full duplex mode and a user equipment (UE) operates in a half duplex mode, and the user equipment (UE) for the same.

### BACKGROUND ART

A full duplex radio (FDR) or full duplex communication scheme refers to a communication scheme for simultaneously supporting transmission and reception using the same resource in one user equipment (UE). In this case, the same resource refers to the same time and the same frequency. FDR communication or full duplex communication is referred to as two-way communication.

FIG. 1 is a diagram illustrating concept of a UE and a base station (BS), which support FDR. Referring to FIG. 1, in a network state that supports FDR, there are three types of interferences. First interference is intra-device self-interference. The intra-device self-interference refers to interference caused by signals that are transmitted from a transmission (Tx) antenna and received by a receiving (Rx) antenna in one BS or UE. Since the signals transmitted from the Tx antenna are transmitted with high power and a distance between the Tx antenna and the Rx antenna is small, the transmitted signals are received by the Rx antenna while attenuation is barely caused, and thus, are received with higher power than a desired signal. Second interference is UE to UE inter-link interference. In a network that supports FDR, the UE to UE inter-link interference is increasingly caused. The UE to UE inter-link interference refers to interference caused by uplink signals that are transmitted from a UE and received by an adjacently positioned UE. Third interference is BS to BS inter-link interference. Similarly, in a network state that supports FDR, BS to BS inter-link interference is increasingly caused. The BS to BS inter-link interference refers to interference caused by signals that are transmitted between BSs or heterogeneous BSs (pico, femto, and relay) in a HetNet state and received by an Rx antenna of another BS.

Among the three types of interferences, the intra-device self-interference (hereinafter, referred to as self-interference) is influence of interference caused only in FDR. In order to manage FDR, a most serious problem is cancellation of self-interference. However, methods for effectively cancelling self-interference in an FDR state have not been discussed in detail.

### DISCLOSURE

### Technical Problem

An object of the present invention is to provide a method for allowing a user equipment (UE) to perform UE-flexible TDD mode communication in a network configured to support a UE-flexible TDD mode in which a base station (BS) operates in a full duplex mode and the UE operates in a half duplex mode.

An object of the present invention is to provide a user equipment (UE) for performing UE-flexible TDD mode communication in a network configured to support a UE-flexible TDD mode in which a base station (BS) operates in a full duplex mode and the UE operates in a half duplex mode.

It is to be understood that technical objects to be achieved by the present invention are not limited to the aforementioned technical objects and other technical objects which are not mentioned herein will be apparent from the following description to one of ordinary skill in the art to which the present invention pertains.

### Technical Solution

The objects of the present invention can be achieved by providing a method for performing communication by a user equipment (UE) in a UE-flexible Time Division Duplex (TDD) mode in a network configured to support the UE-flexible TDD mode in which a base station (BS) operates in a full duplex mode and a user equipment (UE) operates in a half duplex mode including: receiving information regarding UE-specific UL/DL (Uplink/Downlink) configuration configured in the UE from the base station (BS); if a ratio of a UL subframe in the UE-specific UL/DL configuration is greater than ½, receiving a UL downlink control information (DCI) format including an uplink (UL) index value in a scheduled downlink subframe from the base station (BS); and recognizing a scheduled uplink (UL) subframe based on the information regarding the UE-specific UL/DL configuration and the UL index value contained in the UL DCI format, and transmitting an uplink (UL) signal through the scheduled UL subframe. The UE-specific UL/DL configuration established in the UE may be changed according to an amount of traffic required for the UE. The number of scheduled UL subframes may be set to 1 based on the information regarding the UE-specific UL/DL configuration and the UL index value. The information regarding the UE-specific UL/DL configuration configured in the UE may be received through a RRC (Radio Resource Control) signaling. The UE-specific UL/DL configuration configured in the UE may be different from UL/DL configuration configured in another UE that is located in the same cell as the UE.

In accordance with another aspect of the present invention, a user equipment (UE) for performing communication in a UE-flexible Time Division Duplex (TDD) mode in a network configured to support the UE-flexible TDD mode in which a base station (BS) operates in a full duplex mode and the user equipment (UE) operates in a half duplex mode includes: a receiver configured to receive information regarding UE-specific UL/DL (Uplink/Downlink) configuration configured in the UE from the base station (BS), if a ratio of a UL subframe in the UE-specific UL/DL configuration is greater than ½, and to receive a UL downlink control information (DCI) format including an uplink (UL) index value in a scheduled downlink subframe from the base station (BS); and a transmitter configured to recognize a scheduled uplink (UL) subframe based on information regarding the UE-specific UL/DL configuration and the UL index value contained in the UL DCI format, and to transmit an uplink (UL) signal through the scheduled UL subframe. The UE-specific UL/DL configuration configured in the UE may be changed according to an amount of traffic required for the UE. The number of scheduled UL subframes may be set to 1 based on the information regarding the UE-specific UL/DL configuration and the UL index value. The information regarding the UE-specific UL/DL configuration configured in the UE may be received through a RRC (Radio Resource Control) signaling. The UE-specific UL/DL configuration configured in the UE may be different from UL/DL configuration configured in another UE that is located in the same cell as the UE.

### Advantageous Effects

As is apparent from the above description, exemplary embodiments of the present invention can allow a user equipment (UE) to operate in an appropriate UE flexible TDD mode on the basis of the amount of traffic requested by each UE, resulting in increased cell throughput and efficiency.

It will be appreciated by persons skilled in the art thatthat the effects that could be achieved with the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating concept of a user equipment (UE) and a base station (BS), which support full duplex radio (FDR).

FIG. 2 is a block diagram illustrating a structure of BS 105 and a UE 110 in a wireless communication system.

FIG. 3 is a diagram illustrating concept of self-interference.

FIG. 4 is a diagram illustrating signal distortion due to quantization errors and FIG. 5 is a diagram illustration signal recovery when quantization errors are low.

FIG. 5 shows an example in which an interference signal has lower power than a desired signal and the desired signal is recovered after the interference signal is cancelled.

FIG. 6 is a diagram for explanation of a scheme for cancelling self-interference.

FIG. 7 is a diagram for explanation of an antenna interference cancellation (IC) scheme using a distance between antennas.

FIG. 8 is a diagram for explanation of an antenna IC scheme using a phase shifter.

FIG. 9 illustrates interference cancelling performance according to a bandwidth and center frequency of a signal.

FIG. 10 is a diagram illustrating a system obtained by combining interference cancellation (IC) schemes.

FIG. 11 illustrates a structure of a radio frame of 3GPP LTE/LTE-A.

FIG. 12 illustrates a resource grid for one downlink slot of 3GPP LTE/LTE-A.

FIG. 13 illustrates a structure of downlink subframe of 3GPP LTE/LTE-A.

FIG. 14 illustrates a structure of uplink subframe of 3GPP LTE/LTE-A.

FIG. 15 illustrates a frame structure type 1 of 3GPP LTE/LTE-A.

FIG. 16 illustrates a frame structure type 1 of 3GPP LTE/LTE-A.

FIG. 17 is a conceptual diagram illustrating UE-specific TDD (Time Division Duplex).

### BEST MODE

Hereinafter, the preferred embodiments of the present invention will be described in detail with reference to the accompanying drawings. It is to be understood that the detailed description, which will be disclosed along with the accompanying drawings, is intended to describe the exemplary embodiments of the present invention, and is not intended to describe a unique embodiment with which the present invention can be carried out. The following detailed description includes detailed matters to provide full understanding of the present invention. However, it will be apparent to those skilled in the art that the present invention can be carried out without the detailed matters. For example, although the following description will be made based on the assumption that the mobile communication system is the 3GPP LTE or LTE-A system, the following description may be applied to other mobile communication systems except for particular matters of the 3GPP LTE or LTE-A system.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

Moreover, in the following description, it is assumed that a mobile station refers to a mobile or fixed type user equipment such as a user equipment (UE), an advanced mobile station (AMS) and a machine to machine (M2M) device. Also, it is assumed that the base station refers to a random node of a network terminal, such as Node B, eNode B, and access point (AP), which performs communication with the mobile station. In this specification, the base station may be used as a concept that includes a cell, sector, etc.

In a wireless communication system, a mobile station may receive information from a base station through a downlink (DL), and may also transmit information to the base station through an uplink. Examples of information transmitted from and received by the mobile station include data and various kinds of control information. Various physical channels exist depending on types and usage of information transmitted from or received by the mobile station.

The following technology may be used for various wireless access systems such as CDMA (code division multiple access), FDMA (frequency division multiple access), TDMA (time division multiple access), OFDMA (orthogonal frequency division multiple access), and SC-FDMA (single carrier frequency division multiple access). The CDMA may be implemented by the radio technology such as universal terrestrial radio access (UTRA) or CDMA2000. The TDMA may be implemented by the radio technology such as global system for mobile communications (GSM)/general packet radio service (GPRS)/enhanced data rates for GSM evolution (EDGE). The OFDMA may be implemented by the radio technology such as IEEE 802.11 (Wi-Fi), IEEE 802.16 (WiMAX), IEEE 802.20, and evolved UTRA (E-UTRA). The UTRA is a part of a universal mobile telecommunications system (UMTS). A 3rd generation partnership project long term evolution (3GPP LTE) communication system is a part of an evolved UMTS (E-UMTS) that uses E-UTRA, and uses OFDMA in a downlink while uses SC-FDMA in an uplink. LTE-advanced (LTE-A) is an evolved version of the 3GPP LTE system.

Although the following description will be based on the 3GPP LTE/LTE-A to clarify description of the present invention, it is to be understood that the technical spirits of the present invention is not limited to the 3GPP LTE/LTE-A. Also, specific terminologies hereinafter used in the embodiments of the present invention are provided to assist understanding of the present invention, and various modifications may be made in the specific terminologies within the range that they do not depart from technical spirits of the present invention.

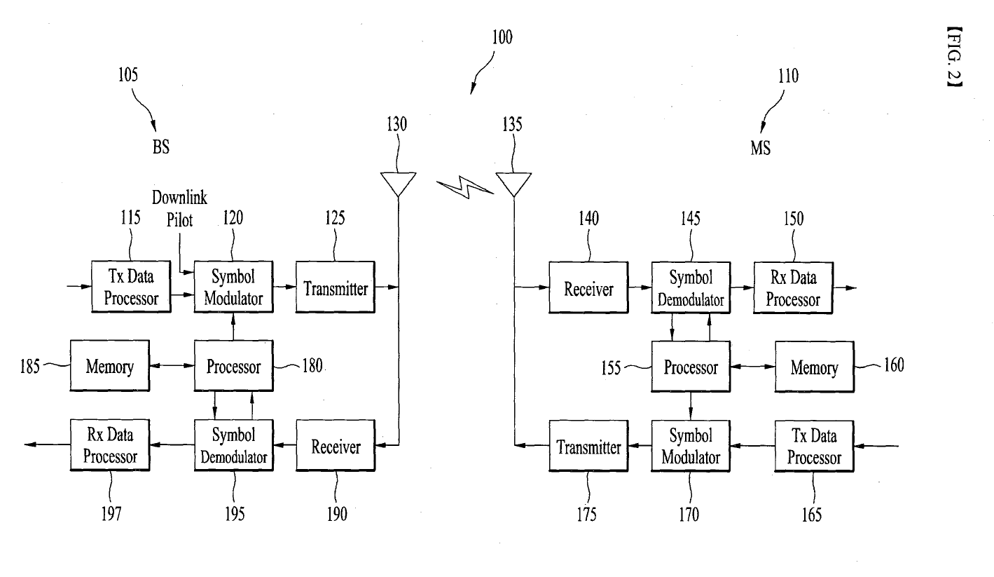

FIG. 2 is a block diagram illustrating configurations of a base station 105 and a mobile station 110 in a wireless communication system.

Although one base station 105, one mobile station 110 are shown for simplification of a wireless communication system 100, the wireless communication system 100 may include one or more base stations and/or one or more mobile stations.

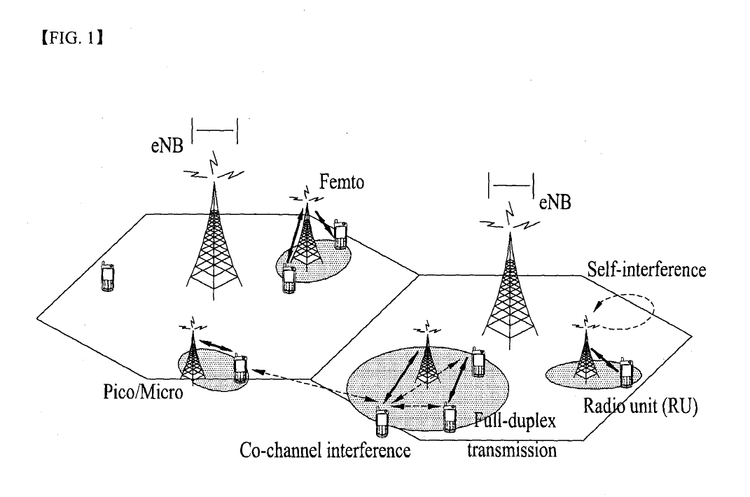

Referring to FIG. 1, the base station 105 may include a transmitting (Tx) data processor 115, a symbol modulator 120, a transmitter 125, a transmitting and receiving antenna 130, a processor 180, a memory 185, a receiver 190, a symbol demodulator 195, and a receiving (Rx) data processor 297. The mobile station 110 may include a Tx data processor 165, a symbol modulator 170, a transmitter 175, a transmitting and receiving antenna 135, a processor 155, a memory 160, a receiver 140, a symbol demodulator 145, and an Rx data processor 150. Although the antennas 130 and 135 are respectively shown in the base station 105 and the mobile station 110, each of the base station 105 and the mobile station 110 includes a plurality of antennas. Accordingly, the base station 105 and the mobile station 110 according to the present invention support a multiple input multiple output (MIMO) system. Also, the base station 105 according to the present invention may support both a single user-MIMO (SU-MIMO) system and a multi user-MIMO (MU-MIMO) system.

On a downlink, the Tx data processor 115 receives traffic data, formats and codes the received traffic data, interleaves and modulates (or symbol maps) the coded traffic data, and provides the modulated symbols (“data symbols”). The symbol modulator 120 receives and processes the data symbols and pilot symbols and provides streams of the symbols.

The symbol modulator 120 multiplexes the data and pilot symbols and transmits the multiplexed data and pilot symbols to the transmitter 125. At this time, the respective transmitted symbols may be a signal value of null, the data symbols and the pilot symbols. In each symbol period, the pilot symbols may be transmitted continuously. The pilot symbols may be frequency division multiplexing (FDM) symbols, orthogonal frequency division multiplexing (OFDM) symbols, time division multiplexing (TDM) symbols, or code division multiplexing (CDM) symbols.

The transmitter 125 receives the streams of the symbols and converts the received streams into one or more analog symbols. Also, the transmitter 125 generates downlink signals suitable for transmission through a radio channel by additionally controlling (for example, amplifying, filtering and frequency upconverting) the analog signals. Subsequently, the downlink signals are transmitted to the mobile station through the antenna 130.

In the configuration of the mobile station 110, the antenna 135 receives the downlink signals from the base station 105 and provides the received signals to the receiver 140. The receiver 140 controls (for example, filters, amplifies and frequency downcoverts) the received signals and digitalizes the controlled signals to acquire samples. The symbol demodulator 145 demodulates the received pilot symbols and provides the demodulated pilot symbols to the processor 155 to perform channel estimation.

Also, the symbol demodulator 145 receives a frequency response estimation value for the downlink from the processor 155, acquires data symbol estimation values (estimation values of the transmitted data symbols) by performing data demodulation for the received data symbols, and provides the data symbol estimation values to the Rx data processor 150. The Rx data processor 50 demodulates (i.e., symbol de-mapping), deinterleaves, and decodes the data symbol estimation values to recover the transmitted traffic data.

Processing based on the symbol demodulator 145 and the Rx data processor 150 is complementary to processing based on the symbol demodulator 120 and the Tx data processor 115 at the base station 105.

On an uplink, the Tx data processor 165 of the mobile station 110 processes traffic data and provides data symbols. The symbol modulator 170 receives the data symbols, multiplexes the received data symbols with the pilot symbols, performs modulation for the multiplexed symbols, and provides the streams of the symbols to the transmitter 175. The transmitter 175 receives and processes the streams of the symbols and generates uplink signals. The uplink signals are transmitted to the base station 105 through the antenna 135.

The uplink signals are received in the base station 105 from the mobile station 110 through the antenna 130, and the receiver 190 processes the received uplink signals to acquire samples. Subsequently, the symbol demodulator 195 processes the samples and provides data symbol estimation values and the pilot symbols received for the uplink. The Rx data processor 197 recovers the traffic data transmitted from the mobile station 110 by processing the data symbol estimation values.

The processors 155 and 180 of the mobile station 110 and the base station 105 respectively command (for example, control, adjust, manage, etc.) the operation at the mobile station 110 and the base station 105. The processors 155 and 180 may respectively be connected with the memories 160 and 185 that store program codes and data. The memories 160 and 185 respectively connected to the processor 180 store operating system, application, and general files therein.

Each of the processors 155 and 180 may be referred to as a controller, a microcontroller, a microprocessor, and a microcomputer. Meanwhile, the processors 155 and 180 may be implemented by hardware, firmware, software, or their combination. If the embodiment of the present invention is implemented by hardware, application specific integrated circuits (ASICs), digital signal processors (DSPs), digital signal processing devices (DSPDs), programmable logic devices (PLDs), and field programmable gate arrays (FPGAs) configured to perform the embodiment of the present invention may be provided in the processors 155 and 180.

Meanwhile, if the embodiment according to the present invention is implemented by firmware or software, firmware or software may be configured to include a module, a procedure, or a function, which performs functions or operations of the present invention. Firmware or software configured to perform the present invention may be provided in the processors 155 and 180, or may be stored in the memories 160 and 185 and driven by the processors 155 and 180.

Layers of a radio interface protocol between the mobile station 110 or the base station 105 and a wireless communication system (network) may be classified into a first layer L1, a second layer L2 and a third layer L3 on the basis of three lower layers of OSI (open system interconnection) standard model widely known in communication systems. A physical layer belongs to the first layer L1 and provides an information transfer service using a physical channel. A radio resource control (RRC) layer belongs to the third layer and provides control radio resources between the mobile station and the network. The mobile station and the base station may exchange RRC messages with each another through the RRC layer.

Throughout this specification, the processor 155 of the UE 110 and the processor 180 of the BS 105 perform an operation for processing signals and data except for a function of receiving or transmitting signals by the UE 110 and the BS 105 or a storing function. However, hereinafter, for convenience of description, the processors 155 and 180 will not be specially stated. Unless the processors 155 and 180 are not stated, a series of operations such as data processing but not the function of transmitting or receiving signals and the storing function may be performed.

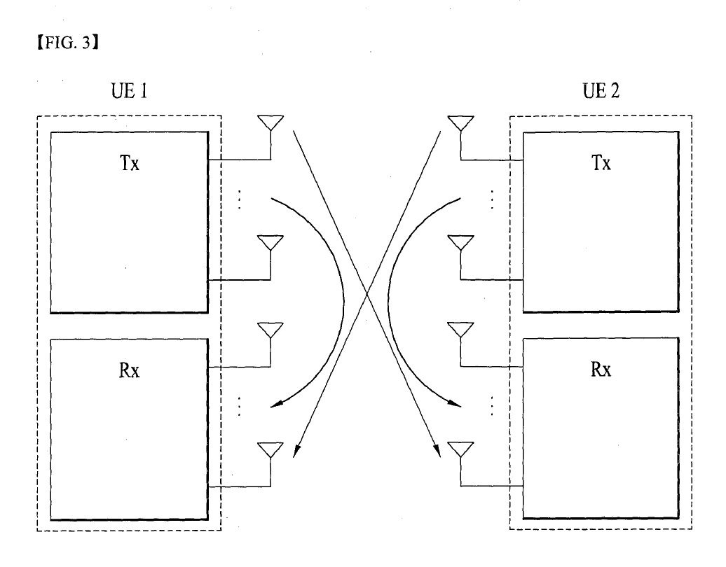

FIG. 3 is a diagram illustrating concept of self-interference.

As illustrated in FIG. 3, a signal transmitted from a UE is received by an Rx antenna of the UE and acts as interference. This interference has different characteristic from other interferences. According to the first characteristic, a signal that acts as interference may be considered as a completely known signal. According to the second characteristic, power of a signal that acts as interference is very high compared with a desired signal. Due to this point, even if a signal that acts as interference is completely known, the interference cannot be completely cancelled at a receiver. The receiver uses an analog to digital converter (ADC) in order to convert a signal received by the receiver into a digital signal. In general, the ADC measures power of a received signal, adjusts a power level of the received signal according to the measured power, quantizes the received signal, and then, converts the signal into a digital signal. However, since an interference signal is received with higher power than a desired signal, the signal characteristic of the desired signal is covered by a quantization level during the quantization, and thus, the signal cannot be recovered.

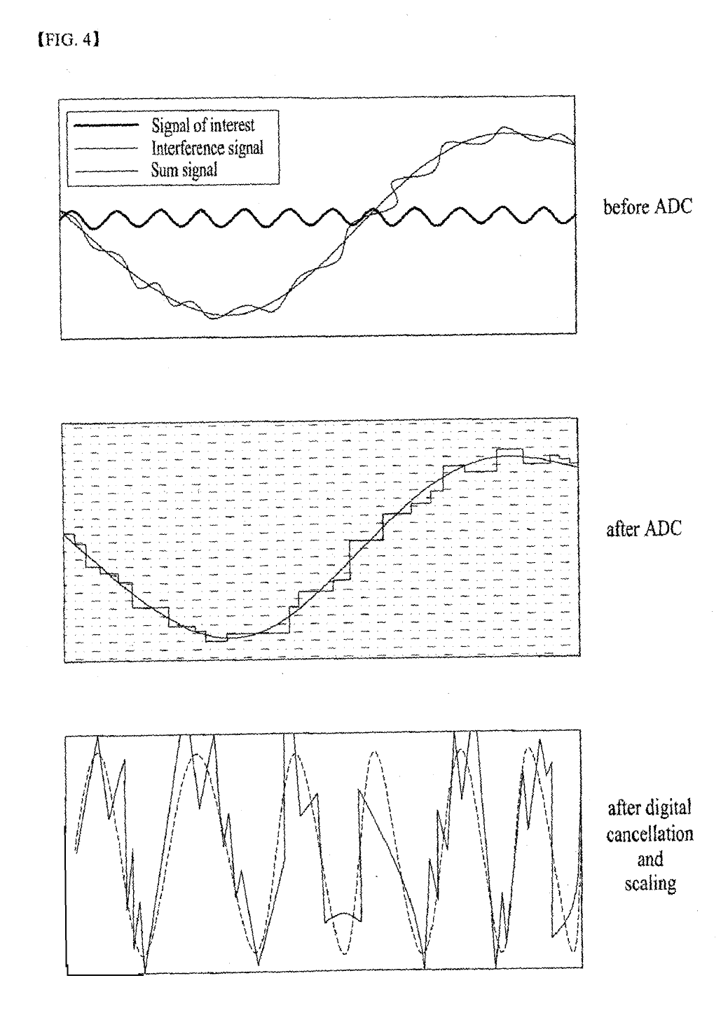

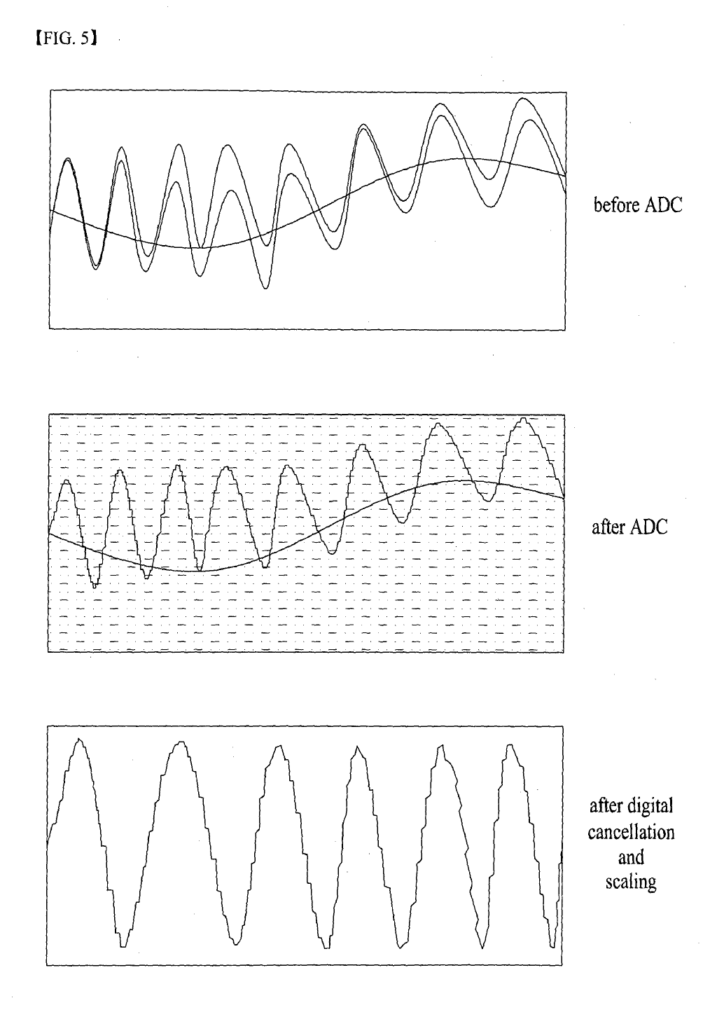

FIG. 4 is a diagram illustrating signal distortion due to quantization errors. FIG. 5 is a diagram illustration signal recovery when quantization errors are low.

In FIG. 4, for example, quantization is assumed to be 4 bits. As seen from FIG. 4, when an interference signal has much higher power than a desired signal, if quantization is performed, even if the interference signal is cancelled, the desired signal is highly distorted. On the other hand, FIG. 5 shows an example in which an interference signal has lower power than a desired signal and the desired signal is recovered after the interference signal is cancelled. In this situation, a scheme for cancelling self-interference may be classified into 4 schemes according to a position in which the scheme is performed.

FIG. 6 is a diagram for explanation of a scheme for cancelling self-interference.

Referring to FIG. 6, the scheme for cancelling self-interference may be classified into 4 schemes of a baseband IC scheme, an ADC IC scheme, an analog IC scheme, and an antenna IC scheme according to a position in which the scheme is performed.

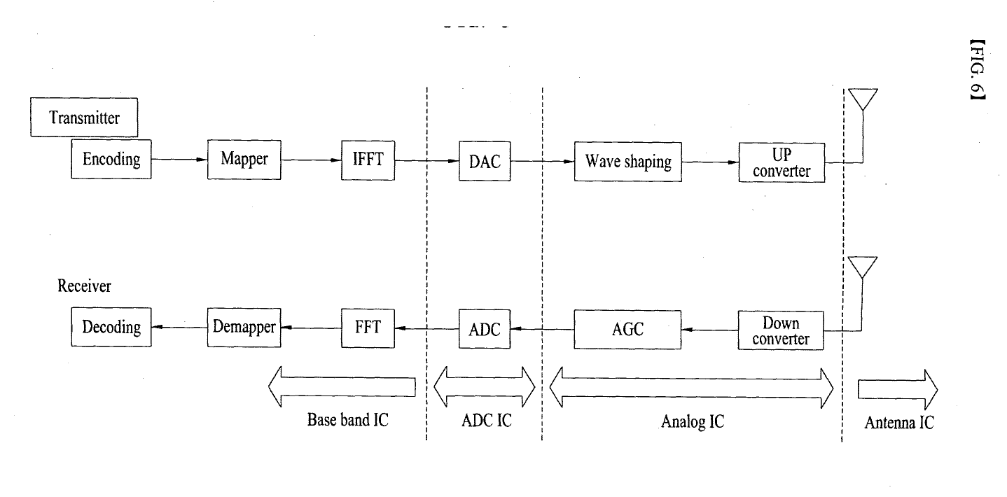

FIG. 7 is a diagram for explanation of an antenna IC scheme using a distance between antennas.

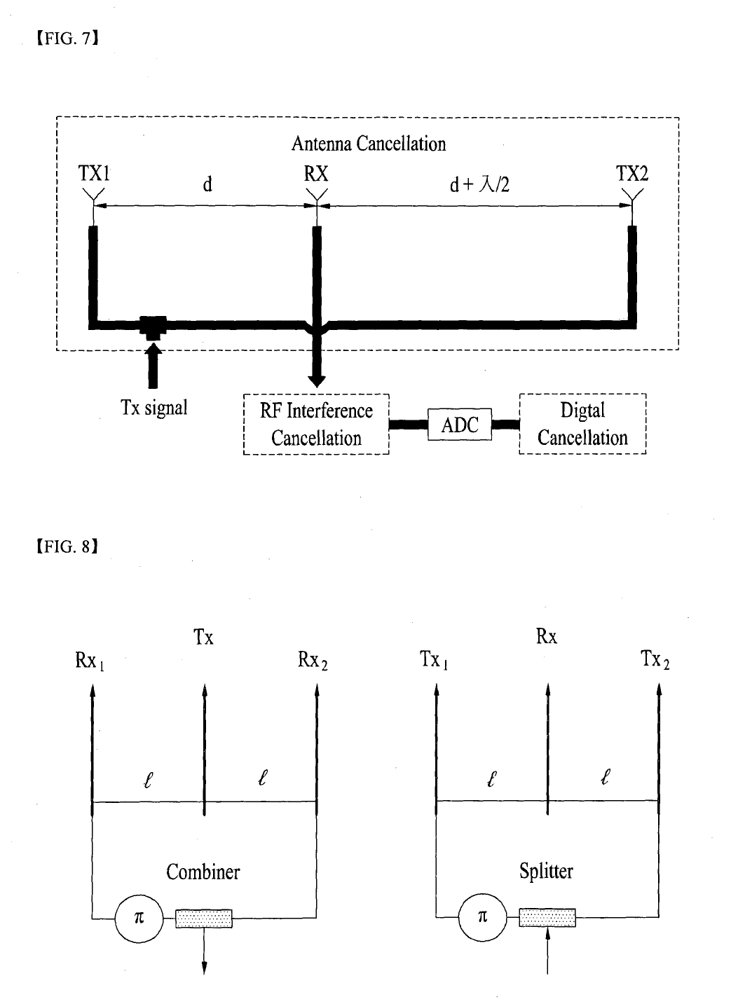

The antenna IC scheme can be implemented via a simplest method among all IC schemes and can be performed as shown in FIG. 7. That is, one UE cancels interference using three antennas and uses two antennas as a Tx antenna and one antenna as an Rx antenna among the three antennas. The two Tx antennas are installed at a distance difference corresponding to about wavelength/2 based on the Rx antenna in order to receive a signal transmitted from each Tx antenna as a signal, a phase of which is inversed, in terms of the Rx antenna. Accordingly, an interference signal among signals that are lastly received by the Rx antenna converges toward 0. Alternatively, in order to inverse a phase of a second Tx antenna, an interference signal can be cancelled using a phase shifter as illustrated in FIG. 8 without using a distance between antennas as illustrated in FIG. 7.

FIG. 8 is a diagram for explanation of an antenna IC scheme using a phase shifter.

In FIG. 8, a left diagram illustrates a scheme for cancelling self-interference using two Rx antennas and a right diagram illustrates a scheme for cancelling interference using two Tx antennas. These antenna interference cancelling schemes are affected by a bandwidth and center frequency of a transmitted signal. As a bandwidth of a transmitted signal is reduced and a center frequency of the transmitted signal is increased, interference cancelling performance is more strengthened. FIG. 9 illustrates interference cancelling performance according to a bandwidth and center frequency of a signal. As illustrated in FIG. 9, as a bandwidth of a transmitted signal is reduced and a center frequency of the transmitted signal is increased, interference cancelling performance is more strengthened.

An ADC IC scheme will now be described. The ADC IC scheme refers to a technology for easily cancelling interference by maximizing the performance of an ADC that has a most serious problem in that interference cannot be cancelled even if an interference signal is pre-known. Although it is disadvantageous in that the ADC IC scheme cannot be applied due to quantization bit limitation of the ADC for actual embodiment, self-interference cancellation performance required by a trend of gradually improving ADC performance may be lowered.

An analog IC scheme will now be described. The analog IC scheme is a scheme for cancelling interference prior to an ADC and cancels self-interference using an analog signal. The analog IC scheme may be performed in a radio frequency (RF) region or performed in an IF region. Interference is cancelled simply by phase and time-lagging a transmitted analog signal and subtracting the analog signal from a signal received by an Rx antenna. The analog IC scheme is advantageous in that only one Tx antenna and one Rx antenna are required unlike the antenna IC scheme. However, since processing is performed using an analog signal, distortion may further occur due to complex implementation and circuit characteristic, thereby highly changing interference cancellation performance.

A digital IC scheme will now be described. The digital IC scheme refers to a scheme for cancelling interference after an ADC and includes any interference cancelation performed in a base band region. As a simplest scheme is embodied by subtracting a transmitted digital signal from a received digital signal. Alternatively, a UE or BS that transmits signals using multi antennas may perform beamforming or precoding so as not to receive the transmitted signal by an Rx antenna. In this regard, when these schemes are performed in a base band, these schemes may also be classified as digital IC. However, the digital IC is possible when a signal modulated in a digital form is quantized so as to recover information about a desired signal. Accordingly, the digital IC is disadvantageous in that an amplitude difference of signal power between a desired signal and an interference signal obtained by cancelling interference via one or more scheme among the above schemes needs to be within an ADC range in order to perform the digital IC.

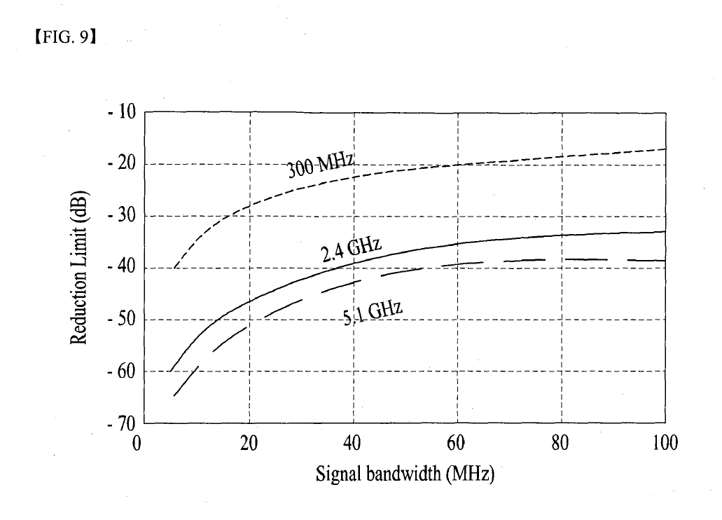

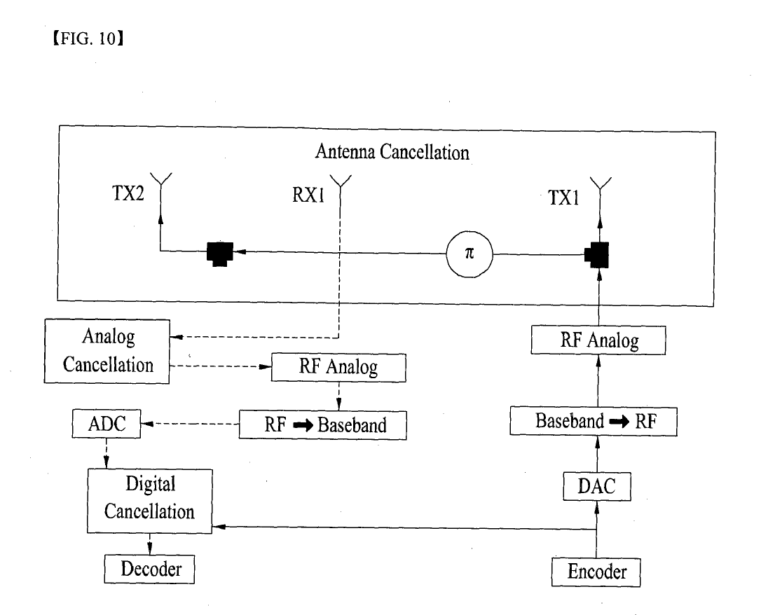

FIG. 10 is a diagram illustrating a system obtained by combining interference cancellation (IC) schemes.

The system illustrated in FIG. 10 is a system to which the above schemes are simultaneously applied and overall interference cancellation performance is improved by combining interference cancellation schemes of respective regions. A scheme proposed according to the present invention proposes a series of procedures and frame structure for cancelling self-interference via a simplest antenna IC scheme among the above schemes and improving overall cell throughput. However, when all of the analog, ADC, and digital IC schemes as well as the antenna IC schemes are applied, even if the scheme proposed according to the present invention, cell throughput may also be improved.

General analog cancellation is achieved via a subtraction method prior to a low noise amplifier (LNA) of a receiver using a signal after a power amplifier (PA) of a transmitter. This is because influence of a signal received by an actual antenna can be effectively reflected only when the signal is extracted from a last node of the transmitter.

FIG. 11 illustrates a structure of a radio frame of 3GPP LTE/LTE-A.

In FIG. 11, a radio frame includes 10 subframes. A subframe includes two slots in time domain. A time for transmitting one subframe is defined as a transmission time interval (TTI). For example, one subframe may have a length of 1 millisecond (ms), and one slot may have a length of 0.5 ms. One slot includes a plurality of orthogonal frequency division multiplexing (OFDM) symbols in time domain. Since the 3GPP LTE uses the OFDMA in the downlink, the OFDM symbol is for representing one symbol period. The OFDM symbol may also be referred to as an SC-FDMA symbol or a symbol period. A resource block (RB) is a resource allocation unit, and includes a plurality of contiguous subcarriers in one slot. The structure of the radio frame is shown for exemplary purposes only. Thus, the number of subframes included in the radio frame or the number of slots included in the subframe or the number of OFDM symbols included in the slot may be modified in various manners.

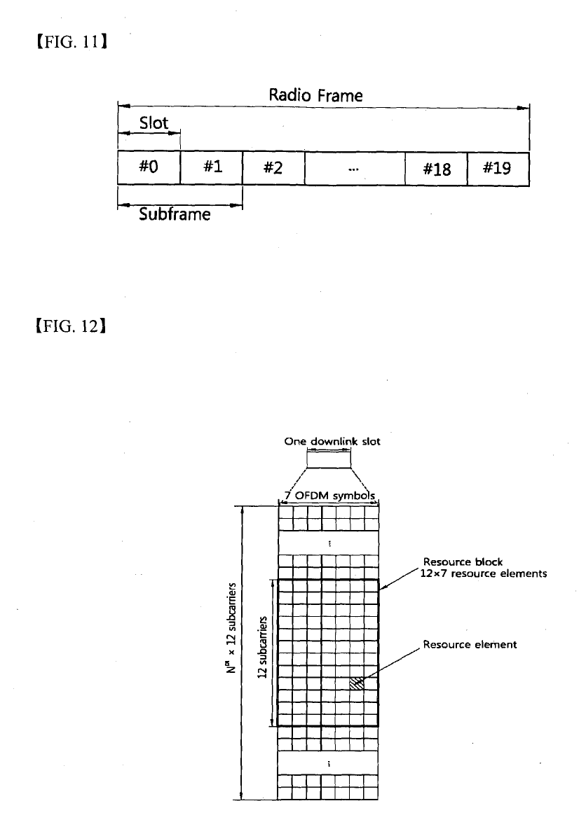

FIG. 12 illustrates a resource grid for one downlink slot of 3GPP LTE/LTE-A.

In FIG. 12, a downlink slot includes a plurality of OFDM symbols in time domain. It is described herein that one downlink slot includes 7 OFDM symbols, and one resource block (RB) includes 12 subcarriers in frequency domain as an example. However, the present invention is not limited thereto. Each element on the resource grid is referred to as a resource element (RE). One RB includes 12×7 REs. The number NDL of RBs included in the downlink slot depends on a downlink transmit bandwidth. The structure of an uplink slot may be same as that of the downlink slot.

FIG. 13 illustrates a structure of downlink subframe of 3GPP LTE/LTE-A.

In FIG. 13, a maximum of three OFDM symbols located in a front portion of a first slot within a subframe correspond to a control region to be assigned with a control channel. The remaining OFDM symbols correspond to a data region to be assigned with a physical downlink shared chancel (PDSCH). Examples of downlink control channels used in the 3GPP LTE includes a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/not-acknowledgment (NACK) signal. Control information transmitted through the PDCCH is referred to as downlink control information (DCI). The DCI includes uplink or downlink scheduling information or includes an uplink transmit (Tx) power control command for arbitrary UE groups.

The PDCCH may carry a transport format and a resource allocation of a downlink shared channel (DL-SCH), resource allocation information of an uplink shared channel (UL-SCH), paging information on a paging channel (PCH), system information on the DL-SCH, a resource allocation of an upper-layer control message such as a random access response transmitted on the PDSCH, a set of Tx power control commands on individual UEs within an arbitrary UE group, a Tx power control command, activation of a voice over IP (VoIP), etc. A plurality of PDCCHs can be transmitted within a control region. The UE can monitor the plurality of PDCCHs. The PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). A format of the PDCCH and the number of bits of the available PDCCH are determined according to a correlation between the number of CCEs and the coding rate provided by the CCEs. The BS determines a PDCCH format according to a DCI to be transmitted to the UE, and attaches a cyclic redundancy check (CRC) to control information. The CRC is masked with a unique identifier (referred to as a radio network temporary identifier (RNTI)) according to an owner or usage of the PDCCH. If the PDCCH is for a specific UE, a unique identifier (e.g., cell-RNTI (C-RNTI)) of the UE may be masked to the CRC. Alternatively, if the PDCCH is for a paging message, a paging indicator identifier (e.g., paging-RNTI (P-RNTI)) may be masked to the CRC. If the PDCCH is for system information (more specifically, a system information block (SIB) to be described below), a system information identifier and a system information RNTI (SI-RNTI) may be masked to the CRC. To indicate a random access response that is a response for transmission of a random access preamble of the UE, a random access-RNTI (RA-RNTI) may be masked to the CRC.

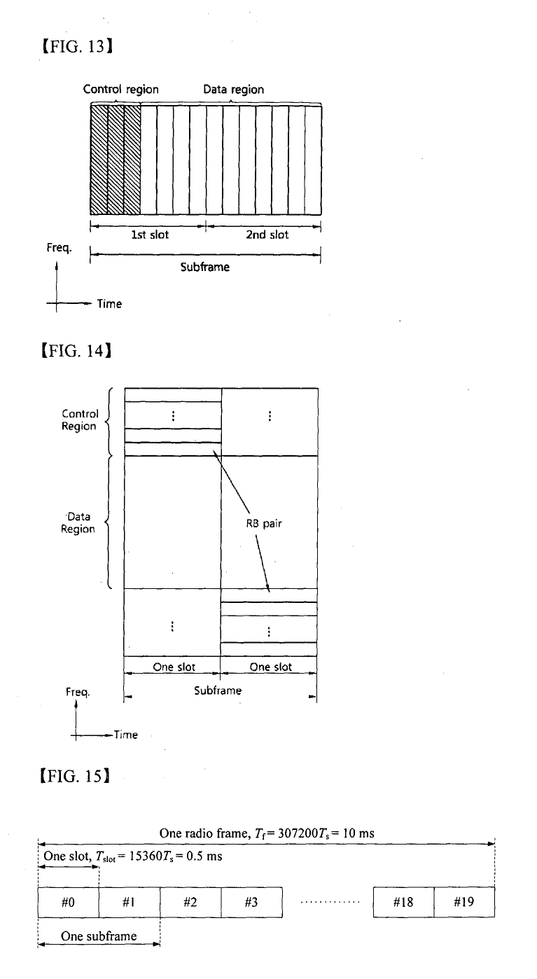

FIG. 14 illustrates a structure of uplink subframe of 3GPP LTE/LTE-A.

In FIG. 14, an uplink subframe can be divided in a frequency domain into a control region and a data region. The control region is allocated with a physical uplink control channel (PUCCH) for carrying uplink control information. The data region is allocated with a physical uplink shared channel (PUSCH) for carrying user data. To maintain a single carrier property, one UE does not simultaneously transmit the PUCCH and the PUSCH. The PUCCH for one UE is allocated to an RB pair in a subframe. RBs belonging to the RB pair occupy different subcarriers in respective two slots. This is called that the RB pair allocated to the PUCCH is frequency-hopped in a slot boundary.

FIG. 15 illustrates a frame structure type 1 of 3GPP LTE/LTE-A.

Frame structure type 1(FDD)

Frame structure type 1 is applicable to both full duplex and half duplex FDD. Each radio frame is T_{f}=07200·Tₛ=10 ms and consists of 20 slots of length Tₛₗₒₜ=15360·Tₛ=0.5 ms numbered from 0 to 19. A subframe is defined as two consecutive slots where subframe i consists of slots 2i and 2i+1. For FDD, 10 subframes are available for downlink transmission and 10 subframes are available for uplink transmissions in each 10 ms interval. Uplink and downlink transmissions are separated in the frequency domain. In half-duplex FDD operation, the UE cannot transmit and receive at the same time while there are no such restrictions in full-duplex FDD.

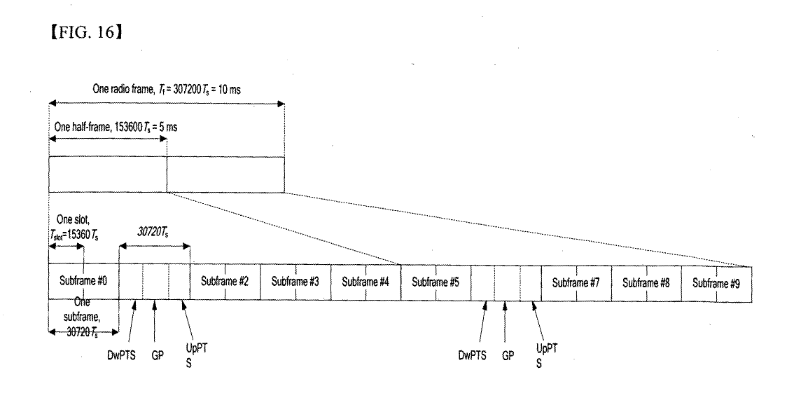

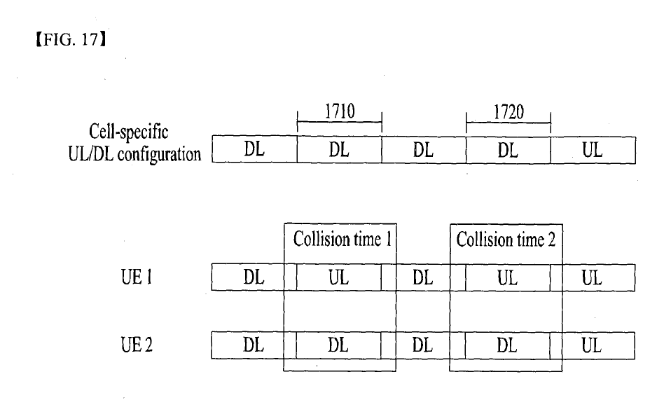

FIG. 16 illustrates a frame structure type 1 of 3GPP LTE/LTE-A.

Frame structure type 2 (TDD)

Frame structure type 2 is applicable to TDD. Each radio frame of length T_{f}=307200·Tₛ=10 ms consists of two half-frames of length 153600·Tₛ=5 ms each. Each half-frame consists of five subframes of length 30720·Tₛ=1 ms. The supported uplink-downlink configurations are listed in Table 7 where, for each subframe in a radio frame, “D” denotes the subframe is reserved for downlink transmissions, “U” denotes the subframe is reserved for uplink transmissions and “S” denotes a special subframe with the three fields DwPTS, GP and UpPTS. The length of DwPTS and UpPTS is given by Table 6 subject to the total length of DwPTS, GP and UpPTS being equal to 30720·Tₛ=1 ms. Each subframe i is defined as two slots, 2i and 2i+1 of length Tₛₗₒₜ=15360·Tₛ=0.5 ms in each subframe. Uplink-downlink configurations with both 5 ms and 10 ms downlink-to-uplink switch-point periodicity are supported.

In case of 5 ms downlink-to-uplink switch-point periodicity, the special subframe exists in both half-frames. In case of 10 ms downlink-to-uplink switch-point periodicity, the special subframe exists in the first half-frame only. Subframes 0 and 5 and DwPTS are always reserved for downlink transmission. UpPTS and the subframe immediately following the special subframe are always reserved for uplink transmission.

Table 1 illustrates configuration of special subframe (lengths of DwPTS/GP/UpPTS).

TABLE 1

| | Normal cyclic prefix in downlink | | | Extended cyclic prefix in downlink | | |
|---|---|---|---|---|---|---|
| | | UpPTS | | | UpPTS | |
| | | Normal | Extended | | Normal | Extended |
| Special | | cyclic | cyclic | | cyclic | cyclic |
| subframe | | prefix | prefix | | prefix | prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

Table 2 illustrates Uplink-downlink configurations.

TABLE 2

| Uplink- | Downlink- | | | | | | | | | | |
|---|---|---|---|---|---|---|---|---|---|---|---|
| downlink | to-Uplink | | | | | | | | | | |
| Config- | Switch-point | Subframe number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

For Frame Structure type 1, an HARQ-ACK received on the PHICH assigned to a UE in subframe i is associated with the PUSCH transmission in subframe i-4. For Frame Structure type 2 UL/DL configuration 1-6, an HARQ-ACK received on the PHICH assigned to a UE in subframe i is associated with the PUSCH transmission in the subframe i-k as indicated by the following table 3.

The BS may inform a UE of UL/DL configuration through a semi-static RRC message. In more detail, the BS may inform the UE of the UL/DL configuration through a ‘subframeassignment’ field of a TDD-Config IE(Information Element).

<UE HARQ-ACK Procedure>

For Frame Structure type 2 UL/DL configuration 1-6, an HARQ-ACK received on the PHICH assigned to a UE in subframe i is associated with the PUSCH transmission in the subframe i-k as indicated by the following table 3.

For Frame Structure type 2 UL/DL configuration 0, an HARQ-ACK received on the PHICH in the resource corresponding to I_{PHICH}=0. assigned to a UE in subframe i is associated with the PUSCH transmission in the subframe i-k as indicated by the following table 8.3-1. If, for Frame Structure type 2 UL/DL configuration 0, an HARQ-ACK received on the PHICH in the resource corresponding to I_{PHICH}=1, assigned to a UE in subframe i is associated with the PUSCH transmission in the subframe i-6.

Table 3 illustrates k for TDD configurations 0-6.

TABLE 3

| TDD UL/DL | subframe number i | | | | | | | | | |
|---|---|---|---|---|---|---|---|---|---|---|
| Configuration | 0 | 1 | 2 | 3 | 4 | 5 | 6 | 7 | 8 | 9 |
| 0 | 7 | 4 | | | | 7 | 4 | | | |
| 1 | | 4 | | | 6 | | 4 | | | 6 |
| 2 | | | | 6 | | | | | 6 | |
| 3 | 6 | | | | | | | | 6 | 6 |
| 4 | | | | | | | | | 6 | 6 |
| 5 | | | | | | | | | 6 | |
| 6 | 6 | 4 | | | | 7 | 4 | | | 6 |

The physical layer in the UE shall deliver indications to the higher layers as follows:

For downlink subframe i, if a transport block was transmitted in the associated PUSCH subframe then:

if ACK is decoded on the PHICH corresponding to the transport block in subframe i, ACK for that transport block shall be delivered to the higher layers;

else NACK for that transport block shall be delivered to the higher layers.

For downlink subframe i, in case of a retransmission in the associated PUSCH subframe, if a transport block was disabled in the associated PUSCH subframe then ACK for that transport block shall be delivered to the higher layers.

<PHICH Assignment Procedure>

For PUSCH transmissions scheduled from serving cell c in subframe n, a UE shall determine the corresponding PHICH resource of serving cell c in subframe n=k_{PHICH}, where k_{PHICH} is always 4 for FDD and is given in table 4 for TDD. For subframe bundling operation, the corresponding PHICH resource is associated with the last subframe in the bundle.

Table 4 illustrates k_{PHICH} for TDD.

TABLE 4

| TDD UL/DL | subframe index n | | | | | | | | | |
|---|---|---|---|---|---|---|---|---|---|---|
| Configuration | 0 | 1 | 2 | 3 | 4 | 5 | 6 | 7 | 8 | 9 |

| | | | | | | |
|---|---|---|---|---|---|---|
| 0 | 4 | 7 | 6 | 4 | 7 | 6 |
| 1 | 4 | 6 | | 4 | 6 | |
| 2 | 6 | | | 6 | | |
| 3 | 6 | 6 | 6 | | | |
| 4 | 6 | 6 | | | | |
| 5 | 6 | | | | | |
| 6 | 4 | 6 | 6 | 4 | 7 | |

The PHICH resource is identified by the index pair (n_{PHICH}^{group}, n_{PHICH}^{seq}) where n_{PHICH}^{group} is the PHICH group number and n_{PHICH}^{seq} is the orthogonal sequence index within the group as defined by:

n_{PHICH}^{group}=(I_{PRB}_{_}_{RA}+n_{DMRS}) mod N_{PHICH}^{group}+I_{PHICH}N_{PHICH}^{group}

n_{PHICH}^{seq}=(└I_{PRB}_{_}_{RA}/ N_{PHICH}^{group}┘+n_{DMRS}) mod 2N_{SF}^{PHICH}

where

n_{DMRS} is mapped from the cyclic shift for DMRS field (according to Table 5) in the most recent PDCCH with uplink DCI format [4] for the transport block(s) associated with the corresponding PUSCH transmission. n_{DMRS} shall be set to zero, if there is no PDCCH with uplink DCI format for the same transport block, and

i. if the initial PUSCH for the same transport block is semi-persistently scheduled, or

ii. if the initial PUSCH for the same transport block is scheduled by the random access response grant.

N_{SF}^{PHICH} is the spreading factor size used for PHICH modulation as described in section 6.9.1 in [3].

$${I}_{PRB \_ RA} = \{ \begin{matrix}{I}_{PRB \_ RA}^{lowest \_ index} & \begin{matrix}for the first TB of a PUSCH with associated PDCCH or for the case of \\ no associated PDCCH when the number of negatively acknowledged \\ TBs is not equal to the number of TBs indicated in the most recent \\ PDCCH associated with the corresponding PUSCH\end{matrix} \\ {I}_{PRB \_ RA}^{lowest \_ index} + 1 & for a second TB of a PUSCH with associated PDCCH\end{matrix}$$

where I_{PRB}_{_}_{RA}^{lower}^{_}^{index} is the lowest PRB index in the first slot of the corresponding PUSCH transmission

N_{PHICH}^{group} is the number of PHICH groups configured by higher layers as described in section 6.9 of [3],

$${I}_{PHICH} = \{ \begin{matrix}1 & for TDD UL \text{/} DL configuration 0 with PUSCH transmission in subframe n = 4 or 9 \\ 0 & otherwise\end{matrix}$$

Table 5 illustrates Mapping between n _{DMRS} and the cyclic shift for DMRS field in PDCCH with uplink DCI format in [4]

TABLE 5

| Cyclic Shift for DMRS Field in | |
|---|---|
| PDCCH with uplink DCI format | |
| in [4] | n_{DMRS} |
| 000 | 0 |
| 001 | 1 |
| 010 | 2 |
| 011 | 3 |
| 100 | 4 |
| 101 | 5 |
| 110 | 6 |
| 111 | 7 |

UE Specific TDD

In a conventional TDD system, the BS and the UE may operate in a half duplex mode while simultaneously having the same cell-specific UL/DL configuration. Therefore, the above-mentioned system structure has difficulty in UE-specifically reflecting the amount of DL or UL traffic required for each UE. In order to address this problem, it may be necessary to UE-specifically establish/manage UL/DL configuration. That is, since individual UEs of one cell may request different amounts of traffic, different UL/DL configurations may be achieved according to the amount of traffic required for each UE, UL/DL configuration is dynamically or semi-statically reflected according to the amount of traffic and is established in each UE through a control channel or RRC (Radio Resource Control) signaling, resulting in increased cell efficiency.

FIG. 17 is a conceptual diagram illustrating UE-specific TDD (Time Division Duplex).

Referring to FIG. 17, UEs of one cell are basically based on the cell-specific UL/DL configuration, and uplink (UL) traffic of UE1 is additionally requested, so that UE1 transmits a UL signal/UL subframe to a downlink (DL) time/DL subframe. In this case, as shown in FIG. 17, two collision times 1710 and 1720 may occur. In Time Duration 1 (1710), BS operates in a DL mode, UE2 operates in the DL mode, and UE1 operates in an uplink (UL) mode, so that the BS must receive a UL signal transmitted from the time duration 1 (1710). The above-mentioned operations are also applied to the other case of Time Duration 2 (1720). For this purpose, the BS can remove self-interference, and may operate in the full duplex mode. That is, in order to operate UE specific TDD, the BS may cancel self-interference and needs to operate in the full duplex mode.

The following Table 6 proposes new UE-specific uplink-downlink configurations to manage UE flexible TDD.

In order to operate the UE flexible TDD, a transmission (Tx) time of a grant message must be defined to schedule the ACK/NACK signal (PHICH) and PUSCH regarding UL data. That is, if the UE detects a UL DCI format or PHICH for the corresponding UE at the n-th subframe, the UE may transmit a PUSCH at the (n+k)-th subframe. In this case, if UL/DL configuration is defined as shown in Table 6, the value of k may be defined as shown in the following Table 7.

TABLE 7
k for UE flexible TDD

| UL/DL | Subframe number | | | | | | | | | |
|---|---|---|---|---|---|---|---|---|---|---|
| configuration | 0 | 1 | 2 | 3 | 4 | 5 | 6 | 7 | 8 | 9 |

| | | | | | | | | | |
|---|---|---|---|---|---|---|---|---|---|
| 0 | | | | | | | | 4 | |
| 1 | | | | | | | | 4 | 4 |
| 2 | 4 | | | | | | | 4 | 4 |
| 3 | 4 | 4 | | | | | | 4 | 4 |
| 4 | 5 | 5 | | | | | 5 | 5 | 5 |
| 5 | 5 | 5 | | | | | | 4 | 4 |
| 5′ | 4 | 4 | | | | | | 4 | 4 |
| 6 | 4 | 4 | | | | | | | 4 |
| 6′ | 5 | 6 | | | | | | | 4 |
| 7 | 4 | 4 | | | | | | | |
| 7′ | 4 | 7 | | | | | | | |
| 8 | | | 4 | | | | | 4 | |
| 9-a | | 6 | | | | | | 4 | 4 |
| 9-b | | | 4 | 4 | | 6 | | | |
| 10-a | | 6 | | 4 | | 6 | | | 4 |
| 10-b | 4 | 6 | | | | | | 4 | 4 |
| 10-c | | | 4 | 4 | 4 | 6 | | | |
| 11-a | 7 | 7 | | | 7 | 7 | | | 5 |
| 11-b | 7 | 7 | | 5 | 7 | 7 | | | |
| 12 | 4 | 6 | | | 4 | 6 | | | |

In Table 6 and Table 7, UL/DL configuration in which a UL subframe occupies at least ½ of one radio frame from among individual UL/DL configurations may be UL/DL configurations #5, #6, #7 and #12. Specifically, UL/DL configuration #12 has the same structure as in TDD UL/DL configuration #0 (i.e., TDD UL/DL configuration #0 of Table 2) of the legacy LTE rel-8/9/10, so that a UL DCI format or a PHICH transmission time and process can be applied for backward compatibility without change. In contrast, UL/DL configurations #5, #6, and #7 can be established in the same manner as in Table 7 and the number of DL subframes is less than the number of UL subframes, so that it is necessary to utilize the UL index field contained in DCI format so as to schedule the UL subframe.

In the case of UL/DL configuration #5, #6, and #7, a method for using the UL index field contained in a DCI format in such a manner that the BS schedules a UL subframe for the UE will hereinafter be described in detail.

The UL index field of 2 bits can be used in UL DCI format 0/4, so that the following description may be defined. The values of k shown in Tables 8, 9, 10, 11, etc. corresponding to the corresponding UL/DL configuration for each UL index are predefined, so that it is assumed that the UE and the BS have already recognized the values of k

In the case of UL index=‘00’, scheduling of a UL subframe denoted by ‘A’ may be indicated according to the k value for each UL/DL configuration (i.e., the subframe denoted by “A” is a UL-scheduled subframe). If UL DCI format or PHICH for the corresponding UE is detected at the n-th subframe (e.g., DL subframe or special subframe), the UE may transmit a PUSCH at the (n+k)-th subframe (UL subframe). In this case, the k values are shown in the following table 8. In this case, the relationship between UL/DL configuration (x) and UL/DL configuration x′ (e.g., the relationship between UL/DL configuration 5 and UL/DL configuration 5′) may be fixed to a system parameter according to any one of alternative methods, and then managed.

For example, as shown in Table 6 of UL/DL configuration #5 shown in Table 8, Subframe Numbers #0, #8 and #9 may indicate DL subframes, and Subframe Number #1 (#=Number, This is “Subframe Number 1”) may indicate a special subframe. In accordance with the k value shown in UL/DL configuration #5 of Table 8 (e.g., the k value of Subframe Number #0 is denoted by 5), the subframe corresponding to Subframe Number #0 may indicate a subframe of n+k (k=5), i.e., the subframe corresponding to Subframe Number #0 may indicate UL scheduling for Subframe Number #5, the subframe corresponding to Subframe Number #1 may indicate UL scheduling for Subframe Number #6, the subframe corresponding to Subframe Number #8 may indicate a UL subframe corresponding to Subframe Number #2 of the next frame in response to the value of k=4, and the subframe corresponding to Subframe Number #9 may indicate that the UL subframe corresponding to Subframe Number #3 of the next frame is scheduled in response to k=4. The UL scheduling scheme for UL/DL configurations (#5′, #6, #6′, #7, and #7′) of Table 8 is identical to that of UL/DL configuration #5.

Therefore, if a UL index field value of 2 bits is set to ‘00’ in UL DCI format 0/4 of a physical downlink control channel (PDCCH) and the BS transmits the UL index field value ‘00’, the UE can recognize which UL subframe is used for scheduling of a physical uplink control channel (PUCCH) and/or a physical uplink shard channel (PUSCH) according to a UL/DL configuration number (shown in Table 8) established in the UE. That is, the UE can recognize that the UL subframe denoted by ‘A’ is scheduled for each UL/DL configuration as shown in Table 8.

If a UL index is set to ‘01’ (i.e., UL index=‘01’), a UL subframe denoted by ‘B’ is scheduled for each ‘k’ value per UL/DL configuration of Table 9. Here, the subframe denoted by ‘B’ shown in Table 9 is a UL-scheduled subframe. If UL DCI format or PHICH for the corresponding UE is detected at the n-th subframe (e.g., DL subframe or special subframe), the UE may transmit a PUSCH at the (n+k)-th subframe (UL subframe). In this case, the value of k is shown in the following Table 9. In this case, the relationship between UL/DL configuration (x) and UL/DL configuration x′ (e.g., the relationship between UL/DL configuration 5 and UL/DL configuration 5′) may be fixed to a system parameter according to any one of alternative methods, and then managed.

For example, as shown in Table 6 of UL/DL configuration #5 shown in Table 8, Subframe Numbers #0, #8 and #9 may indicate DL subframes, and Subframe Number #1 may indicate a special subframe. In accordance with the k value shown in UL/DL configuration #5 of Table 8 (e.g., the k value of Subframe Number #0 is denoted by 6), the subframe corresponding to Subframe Number #0 may indicate a subframe of n+k (k=6), i.e., the subframe corresponding to Subframe Number #0 may indicate UL scheduling for Subframe Number #6, the subframe corresponding to Subframe Number #1 may indicate UL scheduling for Subframe Number #7 in response to the value of k=6, the subframe corresponding to Subframe Number #8 may indicate a UL subframe corresponding to Subframe Number #3 of the next frame in response to the value of k=5, and the subframe corresponding to Subframe Number #9 may indicate that the UL subframe corresponding to Subframe Number #4 of the next frame is scheduled in response to k=5. The subframe denoted by “A” in Table 9 may correspond to a scheduling UL subframe due to “UL index=00” of Table 8.

The UL scheduling schemes of UL/DL configurations (#5′, #6, #6′, #7 and #7′) of Table 9 are identical to those of UL/DL configuration #5.

If a UL index is set to ‘10’ (i.e., UL index=‘10’), a UL subframe denoted by ‘C’ is scheduled for each ‘k’ value per UL/DL configuration of Table 10. Here, the subframe denoted by ‘C’ shown in Table 10 is a UL-scheduled subframe. If UL DCI format or PHICH for the corresponding UE is detected at the n-th subframe (e.g., DL subframe or special subframe), the UE may transmit a PUSCH at the (n+k)-th subframe (UL subframe). In this case, the value of k is shown in the following Table 10. In this case, the relationship between UL/DL configuration (x) and UL/DL configuration x′ (e.g., the relationship between UL/DL configuration #5 and UL/DL configuration #5′) may be fixed to a system parameter according to an alternative method, and then managed.

Meanwhile, in the case of UL/DL configuration #5 and UL/DL configuration #5′, all UL subframes can be scheduled using only two states of the UL index (i.e., UL index=‘00’ and ‘01’), so that the k value can be established using only the LSB(least significant bit) (i.e., ‘0’ or ‘1’) of a UL index. Therefore, the operations generated in one case in which the UL index is set to ‘10’ are identical to those of the other case in which the UL index is set to ‘00’.

For example, as shown in Table 6 of UL/DL configuration #6 of Table 10, Subframe Numbers #0 and #9 may indicate DL subframes, and Subframe Number #1 may indicate a special subframe. In accordance with the k value shown in UL/DL configuration #6 of Table 10 (e.g., the k value of Subframe Number #0 is denoted by 8), the subframe corresponding to Subframe Number #0 may indicate a subframe of n+k (k=8), i.e., the subframe corresponding to Subframe Number #0 may indicate UL scheduling for Subframe Number #8, the subframe corresponding to Subframe Number #1 may indicate scheduling of a UL subframe corresponding to Subframe Number #2 of the next frame in response to the value of k=11, and the subframe corresponding to Subframe Number #8 may indicate scheduling of a UL subframe corresponding to Subframe Number #7 of the next frame in response to the value of k=8. The subframe denoted by ‘A’ in Table 10 may correspond to a scheduling UL subframe due to “UL index=00” of Table 8. The subframe denoted by ‘B’ may correspond to a scheduling UL subframe due to “UL index=01” of Table 9.

The UL scheduling schemes in UL/DL configurations #6, #7 and #7′ of Table 10 are identical to those of UL/DL configuration #6.

If a UL index is set to ‘11’ (i.e., UL index=‘11’), a UL subframe denoted by ‘D’ is scheduled for each ‘k’ value per UL/DL configuration of Table 11. Here, the subframe denoted by ‘D’ shown in Table 11 is a UL-scheduled subframe. If UL DCI format or PHICH for the corresponding UE is detected at the n-th subframe (e.g., DL subframe or special subframe), the UE may transmit a PUSCH at the (n+k)-th subframe (UL subframe). In this case, the value of k is shown in the following Table 11. In this case, the relationship between UL/DL configuration (x) and UL/DL configuration x′ (e.g., the relationship between UL/DL configuration #5 and UL/DL configuration #5′) may be fixed to a system parameter according to any one of alternative methods, and then managed.

Meanwhile, in the case of UL/DL configuration #5 and UL/DL configuration #5′, all UL subframes can be scheduled using only two states of the UL index (i.e., UL index=‘00’ and ‘01’), so that the k value can be established using only the LSB(least significant bit) (i.e., ‘0’ or ‘1’) of a UL index. Therefore, the operations generated in one case in which the UL index is set to ‘11’ are identical to those of the other case in which the UL index is set to ‘01’. In addition, in the case of UL/DL configuration #6, all UL subframes can be scheduled using three states (i.e., UL index=‘00’, ‘01’, ‘10’), so that the case of “UL index=11” and the other case of “UL index=01” may have the same k value, or the k value may be established in consideration of the lowest delay speed as shown in Table 12.

For example, as shown in Table 6 of UL/DL configuration #7 shown in Table 11, Subframe Number #0may indicate a DL subframe, and Subframe Number #1 may indicate a special subframe. In accordance with the k value shown in UL/DL configuration #7 of Table 11 (e.g., the k value of Subframe Number #0 is denoted by 12), the subframe corresponding to Subframe Number #0 may indicate a subframe of n+k (k=12), i.e., the subframe corresponding to Subframe Number #0 may indicate UL scheduling for Subframe Number #2 of the next frame. The subframe corresponding to Subframe Number #1 may indicate scheduling of a UL subframe (i.e., scheduling of UL subframe “D”) corresponding to Subframe Number #3 of the next frame in response to the value of k=12. The subframe denoted by ‘A’ in Table 11 may correspond to a UL subframe scheduled by “UL index=00” of Table 8. The subframe denoted by ‘B’ may correspond to a UL subframe scheduled by “UL index=01” of Table 9. The subframe denoted by ‘C’ may correspond to a UL subframe scheduled by “UL index=10” of Table 10.

The UL scheduling schemes in UL/DL configuration #7′ of Table 10 are identical to those of UL/DL configuration #7.

As described above, if k values are established per UL/DL configuration as shown in Tables 8, 9, 10, and 11, and if the BS informs the UE of the UL index field value of 2 bits, the UL/DL configuration corresponding to at least ½ of the UL subframe rate from among UL/DL configurations may also be efficiently UL-scheduled. The above-mentioned scheduling is based on the principle in which the UL index field transmitted in one DL subframe schedules only one UL subframe. That is, in the legacy TDD mode, UL scheduling for each UL/DL configuration is performed using the UL index field. The UL index value of one subframe must schedule two or more UL subframes. However, during the UE flexible TDD mode, in association with UL/DL configurations configured to occupy at least ½ of the UL subframe rate from among newly added UL/DL configurations, if the k value for each UL/DL configuration is established using the proposed UL index value as shown in Tables 8, 9, 10, and 11, all UL subframes can be scheduled.

On the other hand, if PHICH is transmitted through NACK, the UE must retransmit information over a PUSCH. However, UL/DL configurations configured to occupy at least ½ of the UL subframe rate from among the above-mentioned UL/DL configurations must define which UL subframe will be used for PHICH transmission. As described above, the UL subframe for PUSCH transmission is scheduled according to the following value I_{PHICH}.

$${I}_{PHICH} = \{ \begin{matrix}1 & for TDD UL \text{/} DL configuration 0 with PUSCH transmission in subframe n = 4 or 9 \\ 0 & otherwise\end{matrix}$$

The UL/DL configurations configured to occupy at least ½ of the UL subframe rate from among UL/DL configurations must define which UL subframe will be used for PHICH transmission. A scheduling UL subframe may be indicated using the following value I_{PHICH}.

$${I}_{PHICH} = \{ \begin{matrix}0 & otherwise \\ 1 & \begin{matrix}for TDD UL \text{/} DL configuration 5 with PUSCH transmission in subframe n = 4 or 7 \\ for TDD UL \text{/} DL configuration 5 with PUSCH transmission in subframe n = 6 or 7 \\ for TDD UL \text{/} DL configuration 6 with PUSCH transmission in subframe n = 6 or 7 \\ for TDD UL \text{/} DL configuration {6}^{′} with PUSCH transmission in subframe n = 4 or 6 or 8 \\ for TDD UL \text{/} DL configuration 7 with PUSCH transmission in subframe n = 6 or 7 \\ for TDD UL \text{/} DL configuration {7}^{′} with PUSCH transmission in subframe n = 5 or 9\end{matrix} \\ 2 & \begin{matrix}for TDD UL \text{/} DL configuration 6 with PUSCH transmission in subframe n = 8 or 8 \\ for TDD UL \text{/} DL configuration {6}^{′} with PUSCH transmission in subframe n = 2 \\ for TDD UL \text{/} DL configuration 7 with PUSCH transmission in subframe n = 8 or 9 \\ for TDD UL \text{/} DL configuration {7}^{′} with PUSCH transmission in subframe n = 2 or 6\end{matrix} \\ 3 & \begin{matrix}for TDD UL \text{/} DL configuration 7 with PUSCH transmission in subframe n = 2 or 3 \\ for TDD UL \text{/} DL configuration {7}^{′} with PUSCH transmission in subframe n = 3 or 7\end{matrix}\end{matrix}$$

In addition, a total number of PHICH groups may be established per subframe of each configuration as shown in Table 12.

TABLE 12
The factor mᵢ

| Uplink- | | | | | | | | | | |
|---|---|---|---|---|---|---|---|---|---|---|
| downlink | Subframe number i | | | | | | | | | |
| configuration | 0 | 1 | 2 | 3 | 4 | 5 | 6 | 7 | 8 | 9 |
| 5 | 2 | 2 | — | — | — | — | — | — | 2 | 2 |
| 5′ | 2 | 2 | — | — | — | — | — | — | 2 | 2 |
| 6 | 3 | 3 | — | — | — | — | — | — | — | 3 |
| 6′ | 3 | 3 | — | — | — | — | — | — | — | 3 |
| 7 | 4 | 4 | — | — | — | — | — | — | — | — |
| 7′ | 4 | 4 | — | — | — | — | — | — | — | — |

the number of PHICH groups may vary between downlink subframes and is given by mᵢ·N_{PHICH}^{group} where mᵢ is given by Table 12. The index n_{PHICH}^{group} in a downlink subframe with non-zero PHICH resources ranges from 0 to mᵢ·N_{PHICH}^{group}−1.

The aforementioned embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### INDUSTRIAL APPLICABILITY

As is apparent from the above description, exemplary embodiments of the present invention provide a method for allowing a UE to perform UE-flexible TDD mode communication in a network configured to support the UE-flexible TDD mode in which BS operates in a full duplex mode and the UE operates in a half duplex mode, and the embodiments can be applied to wireless communication systems such as 3GPP LTE/LTE-A for industrial purposes.

1. A method for performing communication by a user equipment (UE) in a UE-flexible Time Division Duplex (TDD) mode in a network configured to support the UE-flexible TDD mode in which a base station (BS) operates in a full duplex mode and a user equipment (UE) operates in a half duplex mode, the method comprising:
receiving information regarding UE-specific UL/DL (Uplink/Downlink) configuration configured in the UE from the base station (BS);
if a ratio of a UL subframe in the UE-specific UL/DL configuration is greater than ½, receiving a UL downlink control information (DCI) format including an uplink (UL) index value in a scheduled downlink subframe from the base station (BS); and
recognizing a scheduled uplink (UL) subframe based on information regarding the UE-specific UL/DL configuration and the UL index value contained in the UL DCI format, and transmitting an uplink (UL) signal through the scheduled UL subframe.

2. The method according to claim 1, wherein the UE-specific UL/DL configuration configured in the UE is changed according to an amount of traffic required for the UE.

3. The method according to claim 1, wherein the number of scheduled UL subframes is set to 1 based on the information regarding the UE-specific UL/DL configuration and the UL index value.

4. The method according to claim 1, wherein the information regarding the UE-specific UL/DL configuration configured in the UE is received through a radio resource control (RRC) signaling.

5. The method according to claim 1, wherein the UE-specific UL/DL configuration configured in the UE is different from UL/DL configuration configured in another UE that is located in the same cell as the UE.

6. A user equipment (UE) for performing communication in a UE-flexible Time Division Duplex (TDD) mode in a network configured to support the UE-flexible TDD mode in which a base station (BS) operates in a full duplex mode and the user equipment (UE) operates in a half duplex mode, the UE comprising:
a receiver configured to receive information regarding UE-specific UL/DL (Uplink/Downlink) configuration configured in the UE from the base station (BS), if a ratio of a UL subframe in the UE-specific UL/DL configuration is greater than ½, and to receive a UL downlink control information (DCI) format including an uplink (UL) index value in a scheduled downlink subframe from the base station (BS); and
a transmitter configured to recognize a scheduled uplink (UL) subframe based on information regarding the UE-specific UL/DL configuration and the UL index value contained in the UL DCI format, and to transmit an uplink (UL) signal through the scheduled UL subframe.

7. The user equipment (UE) according to claim 6, wherein the UE-specific UL/DL configuration configured in the UE is changed according to to an amount of traffic required for the UE.

8. The user equipment (UE) according to claim 6, wherein the number of scheduled UL subframes is set to 1 based on the information regarding the UE-specific UL/DL configuration and the UL index value.

9. The user equipment (UE) according to claim 6, wherein the information regarding the UE-specific UL/DL configuration established in the UE is received through a radio resource control (RRC) signaling.

10. The user equipment (UE) according to claim 6, wherein the UE-specific UL/DL configuration configured in the UE is different from UL/DL configuration configured in another UE that is located in the same cell as the UE.
